(19) United States
(12) Patent Application Publication
(10) Pub. No.: US 2012/0291019 A1
(43) Pub. Date: Nov. 15, 2012

(54) PROGRAM VERIFICATION APPARATUS BASED ON MODEL VERIFYING AND STORAGE MEDIUM

(75) Inventor: Hisashi Enomoto, Mishima-shi (JP)

(73) Assignee: CANON KABUSHIKI KAISHA, Tokyo (JP)

(21) Appl. No.: 13/446,643

(22) Filed: Apr. 13, 2012

(30) Foreign Application Priority Data
May 12, 2011 (JP) 2011-107635

(51) Int. Cl. G06F 11/36

(52) U.S. Cl. 717/126

(57) ABSTRACT

An apparatus includes a unit configured to analyze a program and generate a verification formula for determining whether a specification to be verified out of a language specification of the program is fulfilled; a code generating unit configured to generate a verification code including the generated verification formula; a code composition unit configured to determine, with respect to at least two verification codes generated by the code generating unit, whether or not the two verification codes can be composed to form a single verification code, and compose the two verification codes to form a single verification code if it is possible; and a unit configured to determine, with respect to the at least two verification codes that can be composed, whether the specification to be verified is fulfilled using the verification code composed by the code composition unit.

### BACKGROUND OF THE INVENTION

1. Field of the Invention

The present invention relates to a program verification apparatus based on model verifying technology.

2. Description of the Related Art

Model verifying technology is used as a method of automatically and exhaustively verifying program behaviors. Specifically, a verification formula is generated from a program that is subjected to be verified (hereinafter referred to as a “program to be verified”), and a verification code written in a language corresponding to a model verifying tool such as SPIN and SMV is generated from the verification formula. Then, this verification code is caused to operate on a program verification apparatus so as to confirm whether or not the verification formula is violated.

In model verifying, a problem may occur in that depending on the scale of a program to be verified, execution of verification is impossible due to a large number of states thereof. Accordingly, Japanese Patent Laid-Open No. 7-334566 discloses a configuration in which a program to be verified is divided into program portions having a size that a program verification apparatus can handle.

However, with the method disclosed in Japanese Patent Laid-Open No. 7-334566, the number of verification executions increases due to such division, which results in a longer verification time. Therefore, reducing the verification time while preventing an increase in the number of states has been demanded.

### SUMMARY OF THE INVENTION

The present invention provides a program verification apparatus capable of reducing the verification time, and a storage medium.

According to a first aspect of the present invention, a program verification apparatus includes a verification formula generating unit configured to analyze a content of processing of a program to be verified and generate a verification formula for determining whether or not a specification to be verified out of a language specification of the program to be verified is fulfilled; a verification code generating unit configured to generate a verification code including the generated verification formula; a verification code composition unit configured to determine, with respect to at least two verification codes generated by the verification code generating unit, whether or not the two verification codes can be composed to form a single verification code, and compose the two verification codes to form a single verification code if the composition is possible; and a verification execution unit configured to determine, with respect to the at least two verification codes that can be composed, whether or not the specification to be verified is fulfilled using the verification code composed by the verification code composition unit.

Further features of the present invention will become apparent from the following description of exemplary embodiments with reference to the attached drawings.

### BRIEF DESCRIPTION OF THE DRAWINGS

FIG. 1 is a diagram illustrating a hardware configuration of a program verification apparatus according to an embodiment of the present invention,

FIG. 2 is a functional block diagram of the program verification apparatus according to an embodiment of the present invention,

FIGS. 3A and 3B are diagrams showing a program to be verified according to an embodiment of the present invention,

FIGS. 4A, 4B and 4C are diagrams each showing a verification code for the program to be verified shown in FIGS. 3A and 3B,

FIGS. 5A and 5B are diagrams showing states of the verification codes shown in FIGS. 4A, 4B and 4C that have been converted into verification codes conforming to SPIN,

FIGS. 6A to 6D show verification data according to an embodiment of the present invention,

FIG. 7 shows a flowchart of verification processing performed by the program verification apparatus according to an embodiment of the present invention,

FIG. 8 shows a flowchart of processing of composing verification codes according to an embodiment of the present invention,

FIG. 9 is a diagram showing a source code of a program to be verified according to an embodiment of the present invention,

FIG. 10 is a diagram showing a three address code corresponding to the source code shown in FIG. 9,

FIGS. 11A, 11B and 11C are diagrams each showing a verification code for the program to be verified shown in FIGS. 9 and 10,

FIGS. 12A and 12B are diagrams showing states of the verification codes shown in FIGS. 11A, 11B and 11C that have been converted into verification codes conforming to SPIN,

FIGS. 13A to 13D show verification data according to an embodiment of the present invention,

FIGS. 14A and 14B are diagrams showing a program to be verified according to an embodiment of the present invention,

FIGS. 15A and 15B are diagrams showing verification codes for the program to be verified shown in FIGS. 14A and 14B,

FIGS. 16A and 16B are diagrams showing states of the verification codes shown in FIGS. 15A and 15B that have been converted into verification codes conforming to SPIN, and

FIGS. 17A to 17D show verification data according to an embodiment of the present invention.

### DESCRIPTION OF THE EMBODIMENTS

### First Embodiment

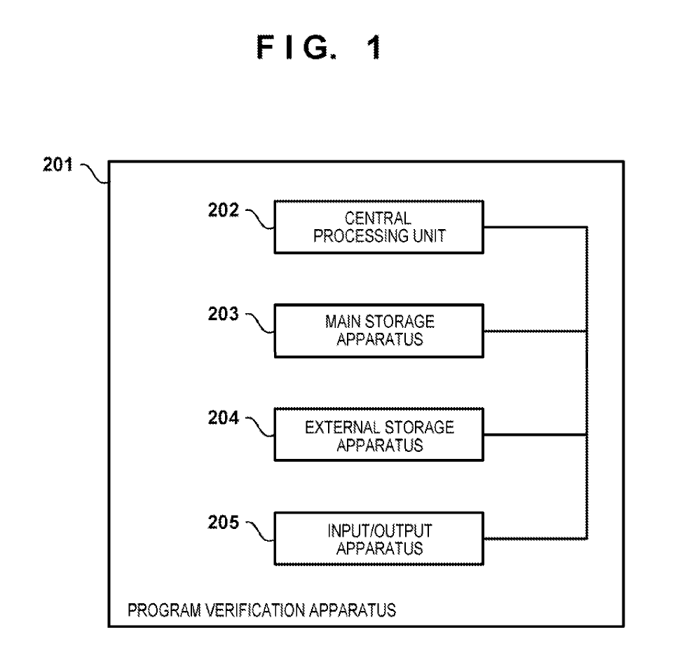

FIG. 1 is a diagram illustrating a hardware configuration of a program verification apparatus 201 according to an embodiment of the present invention. For example, a program to be verified and a program for verification apparatus are stored in an external storage apparatus 204 such as a hard disk. A central processing unit 202 realizes the program verification apparatus 201 as described below by loading the program for verification apparatus in a main storage apparatus 203 and executing the program. That is, the program verification apparatus 201 can be realized by a program causing a computer to function as the program verification apparatus 201 to be described below. The program verification apparatus 201 verifies whether a program to be verified fulfills a specification to be verified, which is a specification subjected to verification out of the language specification of the program to be verified. Note that an input/output apparatus 205 includes, for example, a display apparatus such as a display, and an input apparatus such as a keyboard or a mouse, and performs input processing of an instruction from a user and the like to the program verification apparatus 201, and output processing of a verification result display to a user and the like.

A description is provided below by using, as an example, a case in which a program to be verified is written in the C language, and the specifications to be verified are “out-of-array memory access must not be performed” (hereinafter referred to as “out-of-array reference”) and “division by 0 must not be executed” (hereinafter referred to as “DIV 0”). Note that verification codes executed by the program verification apparatus 201 are written in SPIN.

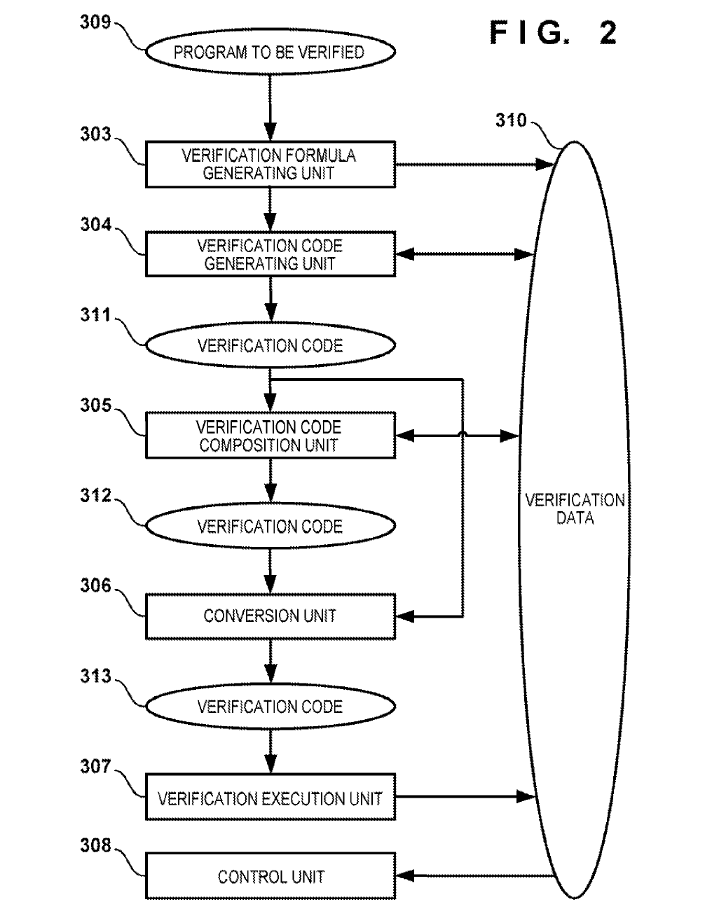

FIG. 2 is a functional block diagram of the program verification apparatus 201 according to the present embodiment. A verification formula generating unit 303 analyzes the content of processing of a program to be verified 309, generates a verification formula for determining whether a specification to be verified is fulfilled, and outputs the generated verification formula as verification data 310.

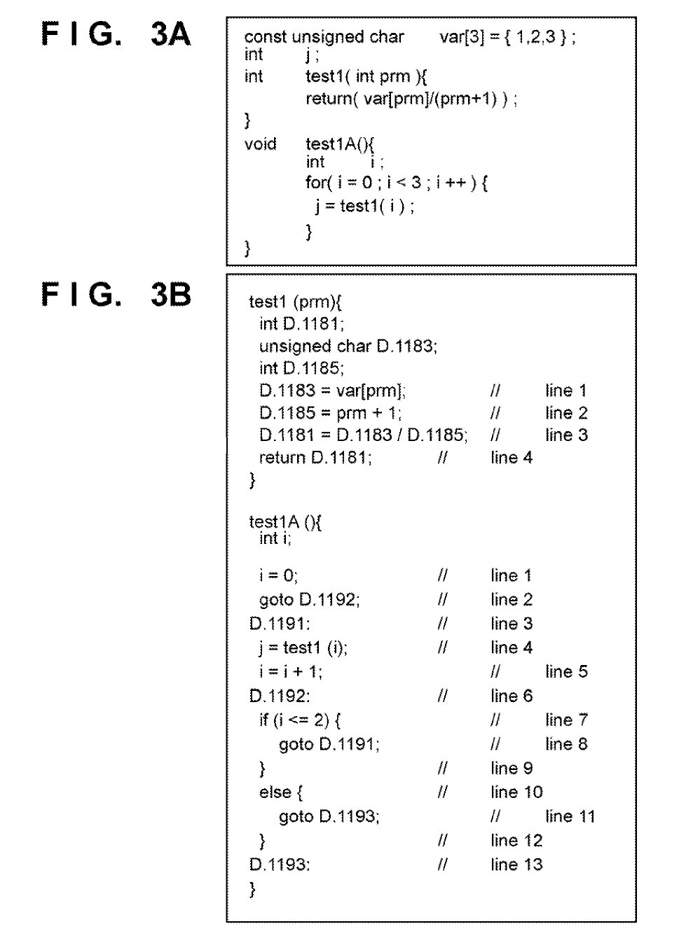

FIGS. 3A and 3B each show the program to be verified 309 used for describing the present embodiment. Note that FIG. 3A shows a source code written in the C language, and FIG. 3B shows a three address code in a form such as a static single assignment (SSA) obtained by converting the source code shown in FIG. 3A. Note that various known methods may be used for conversion from a source code to a three address code. For example, initially, the verification formula generating unit 303 converts the source code shown in FIG. 3A into the three address code shown in FIG. 3B. Then, the verification formula generating unit 303 determines a processing portion corresponding to a specification to be verified, based on the source code and the three address code, and generates a verification formula for each processing portion.

Specifically, the following matters can be understood based on the program to be verified shown in FIGS. 3A and 3B.

In the line 1 of a function test1 in FIG. 3B, an array var is accessed using prm as an index.

In the line 3 of the function test1 in FIG. 3B, division by D.1185 is executed. Note that from the line 2, D.1185 is equivalent to prm+1.

prm is an argument of test1, and is not changed between the lines 1 and 3 of the function test1.

Based on FIG. 3A, the number of elements of the array var is three.

Based on the matters described above, with respect to the function test1, it is understood that the processing portion corresponding to “out-of-array reference” is the line 1, and that it is sufficient to verify whether prm is not less than 0 and not more than 3 in the access to the array var in the line 1. That is, the verification formula for “out-of-array reference” corresponding to the processing portion in the line 1 is (0≦prm&&prm<3). Similarly, it is understood that the processing portion corresponding to “DIV 0” is the line 3, and it is sufficient to verify whether D.1185=prm+1, which relates to line 3, is not 0. That is, the verification formula for “DIV 0” is (prm+1!=0).

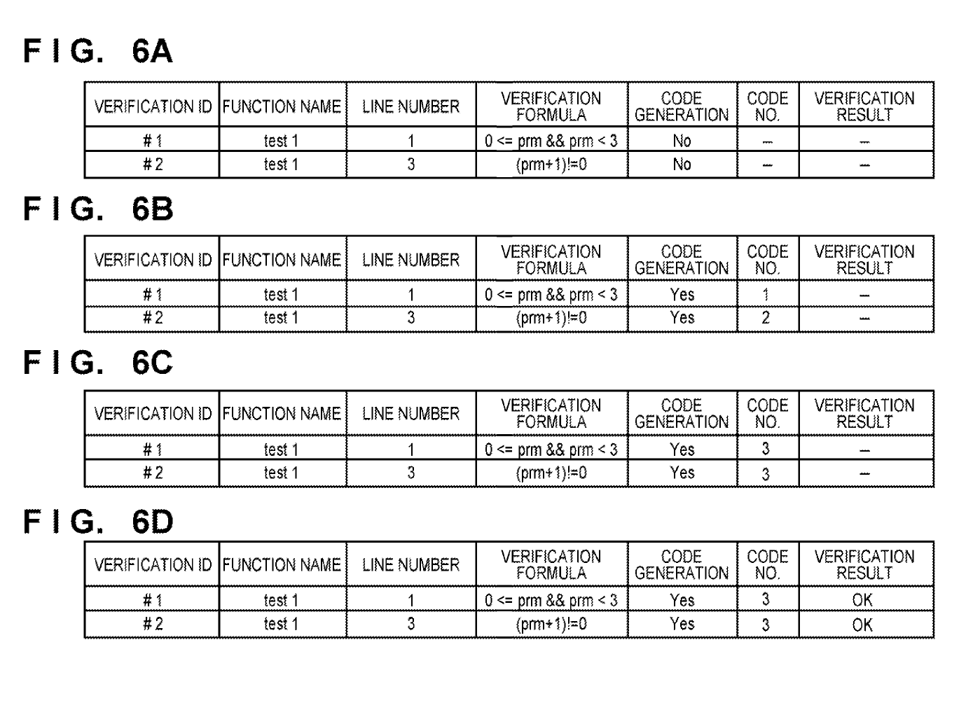

Accordingly, the verification formula generating unit 303 outputs verification data 310 shown in FIG. 6A. In FIG. 6A, a verification ID field indicates the identifier of a verification formula, a function name field indicates the name of a function to be verified, and a line number field indicates the processing portion corresponding to a specification to be verified and is indicated by the line number in the three address code shown in FIG. 3B. Also, a verification formula field indicates the verification formula corresponding to the specification to be verified, and a code generation field indicates whether a verification code has already been generated. Since the verification code has not been generated at this time, “No” is set in the code generation field. Further, a code number field indicates the number of a verification code if it has been generated, and a verification result field indicates whether the verification formula fulfills a specification to be verified.

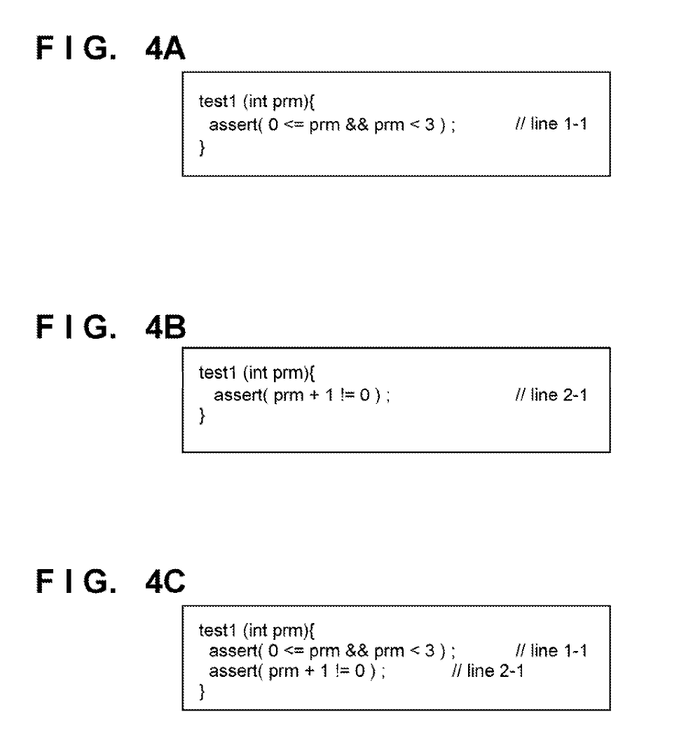

Returning to FIG. 2, a verification code generating unit 304 generates verification codes 311 for verifying “out-of-array reference” and “DIV 0”, which are specifications to be verified, from the verification data 310 shown in FIG. 6A and the program to be verified shown in FIGS. 3A and 3B. Known code-slicing methods can be used for generating each verification code 311. That is, the verification code generating unit 304 generates each verification code 311 by checking the dependency relation in the program to be verified, deleting the code of the program to be verified except a portion of the code that influences values related to the specification to be verified, and embedding a verification formula in the code. FIG. 4A shows a verification code 311 corresponding to the verification formula with the verification ID #1 shown in FIG. 6A, and FIG. 4B shows a verification code 311 corresponding to the verification formula with the verification ID #2 shown in FIG. 6A. As shown in FIG. 4A, the verification code 311 corresponding to the verification ID #1 is generated by leaving only a portion of the code in the function test1 shown in FIG. 3B, the portion influencing the value of prm in the line 1 that is related to the verification formula. Also, as a result of generating the verification code, the verification code generating unit 304 sets “Yes” in the code generation field of the verification data and sets the corresponding number in the code number field as shown in FIG. 6B.

Next, a verification code composition unit 305 performs processing of composing verification codes for each function. Although the composition processing will be described later in detail, since the two verification codes shown in FIGS. 4A and 4B use the same variable, the two verification codes can be composed. FIG. 4C shows a verification code 312 obtained by composition (“composed verification code 312”) output by the verification code composition unit 305. Note that although the assert statements are written in order in FIG. 4C, they may be written as a single verification formula, for example, (0!=prm+1)&&(0≦prm&&prm<3). Also, the verification code composition unit 305 sets the corresponding number in the code number field as shown in FIG. 6C as a result of generating the verification code.

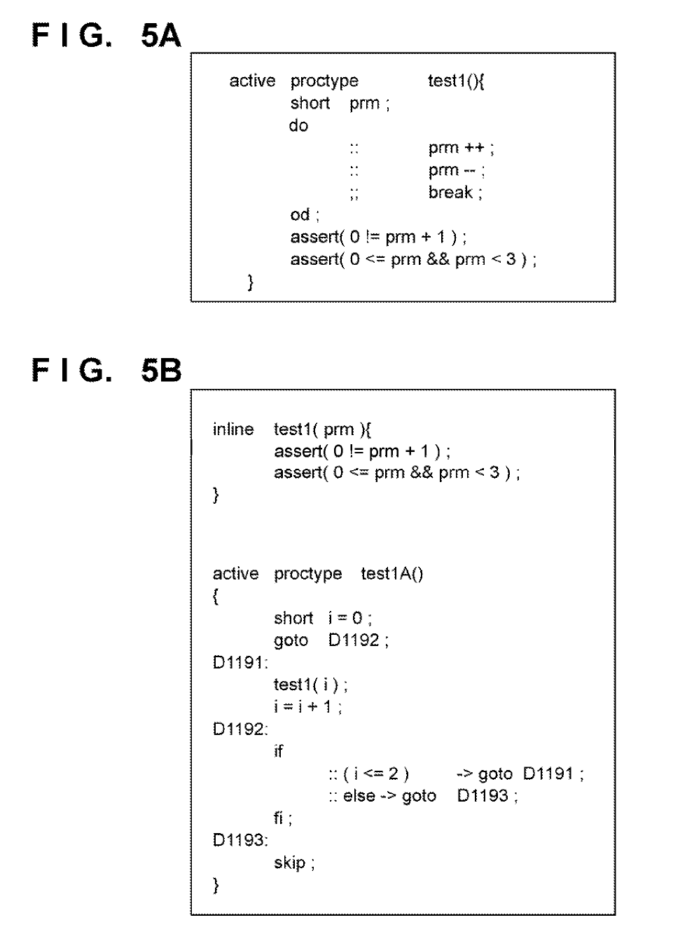

Next, a conversion unit 306 converts the verification codes 311 or the verification code 312 into a verification code 313 that conforms to the model verifying language supported by the program verification apparatus. More specifically, with respect to the verification formulae that have been composed by the verification code composition unit 305, the composed verification code 312 is converted into a verification code 313, and with respect to the verification formulae that have not been composed, the verification codes 311 are each converted into a verification code 313. FIG. 5A shows a state of the verification code 312 in FIG. 4C after conversion when the model verifying language is SPIN. With the verification code 313 shown in FIG. 5A, it is possible to perform verification while limiting the verification region to within the function.

A verification execution unit 307 reads the verification code 313, determines whether the specification to be verified is fulfilled, and sets the determination result in the verification result field of the verification data 310. Here, if the specification to be verified is not fulfilled (NG), a control unit 308 determines whether there is an out-of-scope variable. That is, the presence of a variable that takes an indefinite value in a function itself that is subjected to verification is determined. In the function test1 (first function) of the program to be verified shown in FIG. 3B, prm is an out-of-scope variable and the value thereof cannot be determined, and thus the verification execution unit 307 outputs a determination result of “NG” for the verification code 313 of FIG. 5A. In this case, the control unit 308 identifies another function related to the function test1, and controls the units in FIG. 2 such that the verification scope is expanded to the related function and the above-described processing is executed again. As shown in FIG. 3B, since the function test1 is called in the line 4 of a function test1A (second function), the control unit 308 determines that the function test1A is related to the function test1. Therefore, in the second time of execution, the control unit 308 treats the functions test1 and test1A as a single verification scope. FIG. 5B shows a verification code 313 when the functions test1 and test1A are added to the verification scope. Since the verification code 313 in FIG. 5B fulfills the specification to be verified (OK), the verification execution unit 307 sets “OK” in the verification result field as shown in FIG. 6D.

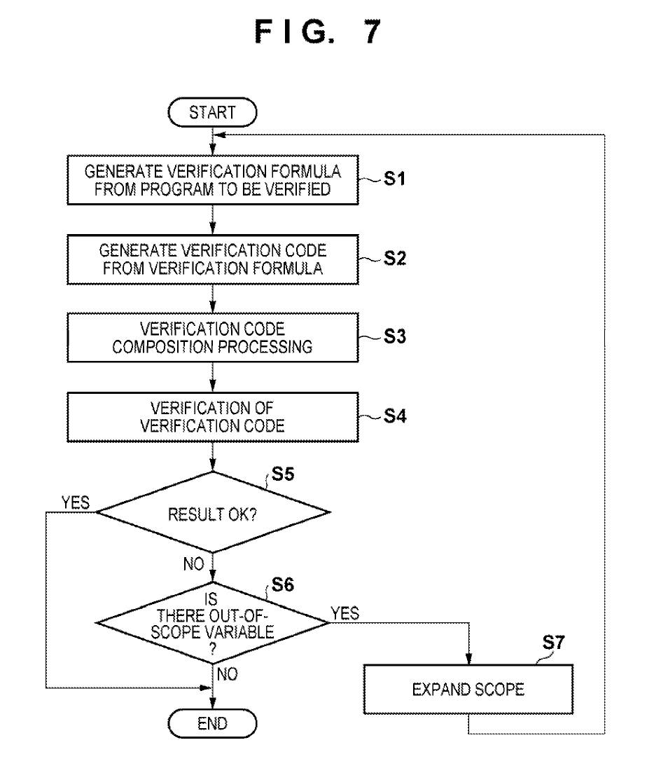

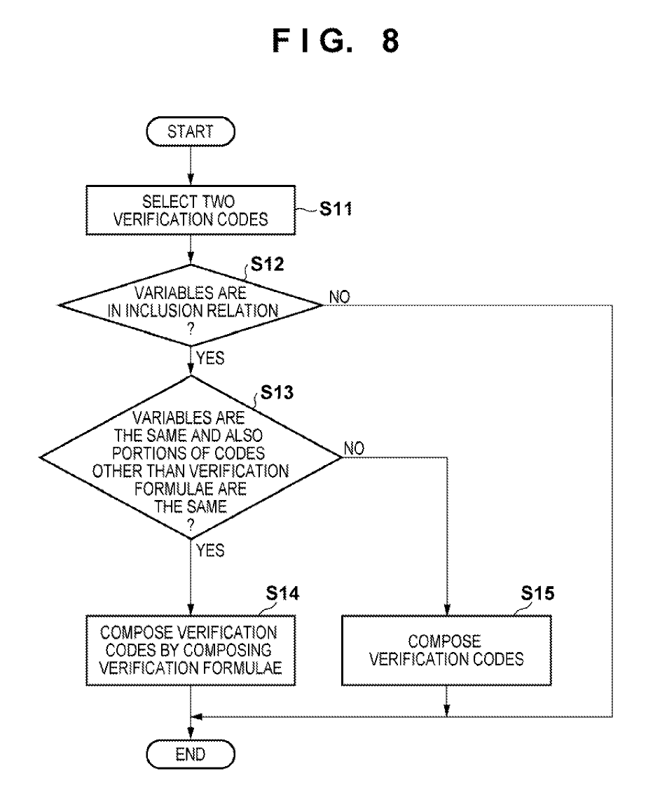

Next, program verification processing according to the present embodiment will be described using FIGS. 7 and 8. In step S1 in FIG. 7, the verification formula generating unit 303 analyzes the content of processing of the program to be verified 309, and generates a verification formula as shown in FIG. 6A for each processing portion related to a specification to be verified. In step S2, the verification code generating unit 304 generates a minimum required verification code 311 for verifying each verification formula for each function. That is, the verification code generating unit 304 generates a verification code 311 for each verification formula generated by the verification formula generating unit 303. Known code-slicing methods can be used for generating the verification codes 311 shown in FIGS. 4A and 4B.

Next, in step S3, the verification code composition unit 305 performs processing of composing verification codes 311 for each function. FIG. 8 is a flowchart of the composition processing performed by the verification code composition unit 305. Note that the processing illustrated in FIG. 8 is executed for each function. In step S11, the verification code composition unit 305 selects, from the verification data 310, two verification codes 311 in the same function to be processed. For example, in the verification data 310 shown in FIGS. 6A to 6D, two verification codes 311 identified by the verification IDs #1 and #2 are selected to be processed. In step S12, the verification code composition unit 305 determines whether the variables of the verification codes 311 are in an inclusion relation. The inclusion relation refers to a state in which all variables of one verification code 311 are used as the variables in the other verification code 311 as well. Note that the variables are determined to be the same if they have the same name and type. If the verification codes 311 are not in the inclusion relation, the verification code composition unit 305 determines that the two selected verification codes 311 cannot be composed, and ends the processing. On the other hand, if the verification codes 311 are in the inclusion relation, the verification code composition unit 305 determines in step S13 whether the variables of the verification codes 311 are the same, and also whether the codes other than the verification formulae are the same. If the variables of the verification codes 311 are the same, and also the codes other than the verification formulae are the same, the verification code composition unit 305 composes the verification formulae in step S14, and thereby generates a composed verification code 312. On the other hand, if the variables of the codes or the codes other than the verification formulae are not the same, the verification code composition unit 305 simply composes the selected verification codes 311 in step S15. For example, the variables prm used in the verification codes 311 shown in FIGS. 4A and 4B are the same since they have the same name and type (integer: int). Also, the portions of the verification codes 311 subsequent to the verification formulae, namely, the assert statements, are the same (more precisely, there are only the assert statements), and thus “Yes” is obtained in step S13.

Note that the determination made in step S13 is an option, and the verification codes 311 can be composed if the determination result in step S12 is “Yes”. If there are three or more verification codes 311 for a certain function, the verification code composition unit 305 can, for example, select all the verification codes 311 in step S11, determine a combination of verification codes for which composition is possible through the processing in steps S12 to S15, and thereby generate the composed verification code 312. Alternatively, it is possible to compose three or more verification codes by, with respect to one verification code 311 of interest, selecting another verification code 311 and repeating the processing illustrated in FIG. 8. In this case, if a verification code 311 of interest has undergone composition in the foregoing processing to generate a composed verification code 312, in the subsequent step S11 in FIG. 8, that composed verification code 312 and another verification code 311 are selected. On the other hand, if composition of a verification code 311 of interest has been impossible in the foregoing processing, in subsequent step S11 in FIG. 8, that verification code 311 of interest and another verification code 311 are selected to be processed. In any case, the verification codes are composed within each function.

Returning to FIG. 7, in step S4, the conversion unit 306 converts the verification codes 311 and/or the verification code 312 into a verification code 313 that conforms to the model verifying program language to be used, and the verification execution unit 307 reads the verification code 313 to determine whether the specification to be verified is fulfilled. In step S5, the control unit 308 determines whether the determination result is “OK” or “NG”, and ends the processing if the determination result is “OK”. On the other hand, if the determination result is “NG”, in step S6, it is determined whether there is an out-of-scope variable. If there is no out-of-scope variable, the control unit 308 causes the processing to end, but if there is an out-of-scope variable, in step S7, the control unit 308 expands the verification scope subjected to verification code generation, and executes processing from step S1. Note that “expanding the verification scope subjected to verification code generation” means executing the processing from steps S1 to S7 on a plurality of mutually related functions, which include other functions related to a function for which the determination result “NG” has been obtained, as described above. That is, in the second and subsequent times of execution, the verification code generating unit 304 executes code slicing while taking a plurality of functions included in the verification scope into account.

As described above, in the present embodiment, after the verification codes are composed in a function, first, verification is performed. Thereafter, if the verification result is “NG”, the verification is repeatedly performed while expanding the verification scope, thereby enabling reliable program verification without increasing the number of states. For example, in the program to be verified shown in FIG. 3, as with conventional techniques, if composition in a function is not performed, it is required to perform verification four times. In contrast, in the present embodiment, it is possible to obtain a verification result through two iterations of the verification by composing the verification codes 311 in a function. In this manner, with the configuration of the present embodiment, it is possible to reduce the verification time. Note that since variables used in verification do not change before and after composition, there is little possibility that the number of states is increased due to composition.

### Second Embodiment

In the first embodiment, the determination results in steps S12 and S13 in FIG. 8 are both “Yes”. A case will be described below in which the determination result in step S12 is “Yes”, and the determination result in step S13 is “No”.

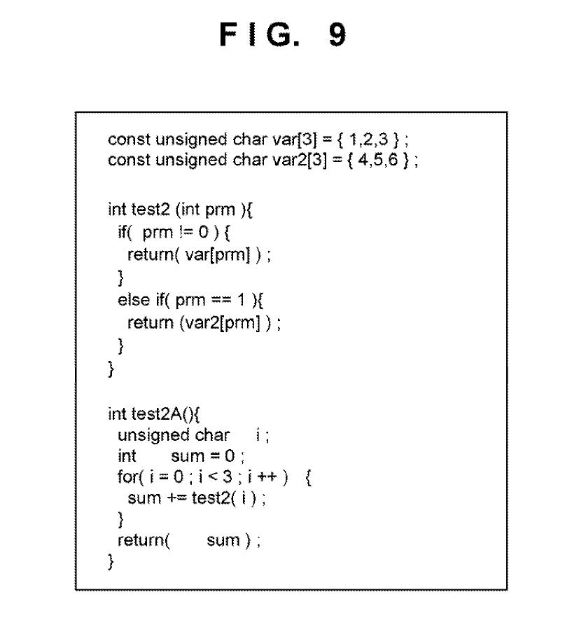

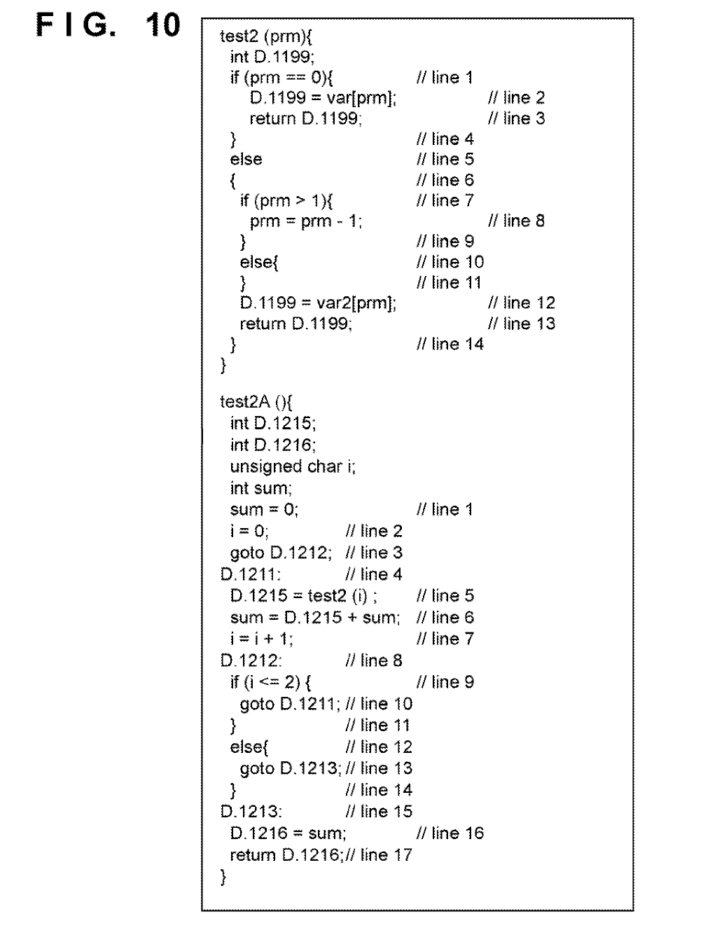

FIG. 9 shows the source code of a program to be verified 309, and FIG. 10 shows a three address code corresponding to the source code shown in FIG. 9. The following matters can be understood based on the program to be verified 309 shown in FIGS. 9 and 10.

In the line 2 of a function test2 shown in FIG. 10, an array var is accessed using prm as an index.

In the line 12 of the function test2 shown in FIG. 10, an array var2 is accessed using prm as an index.

prm is an argument of test2, and is not changed between the lines 1 and 12 of the function test2.

Based on FIG. 9, the numbers of elements of the arrays var and var2 are each three.

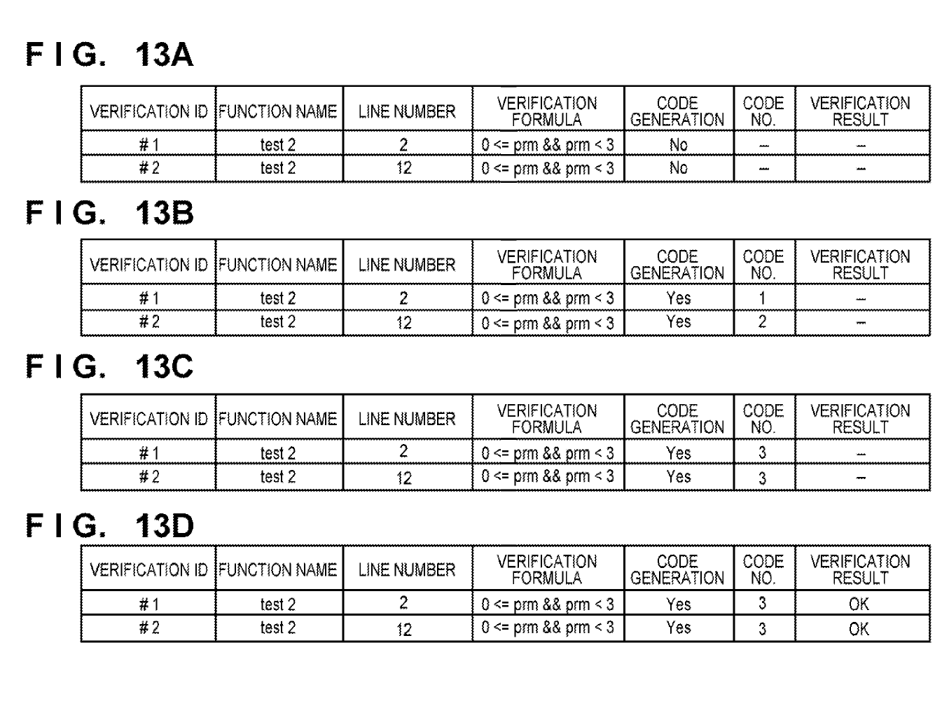

Based on the matters described above, with respect to “out-of-array reference” in the function test2, it is understood that it is sufficient to verify whether prm is not less than 0 and not more than 3 in the access to the arrays var and var2 in the lines 2 and 12. The verification formula generating unit 303 accordingly outputs verification data 310 shown in FIG. 13A.

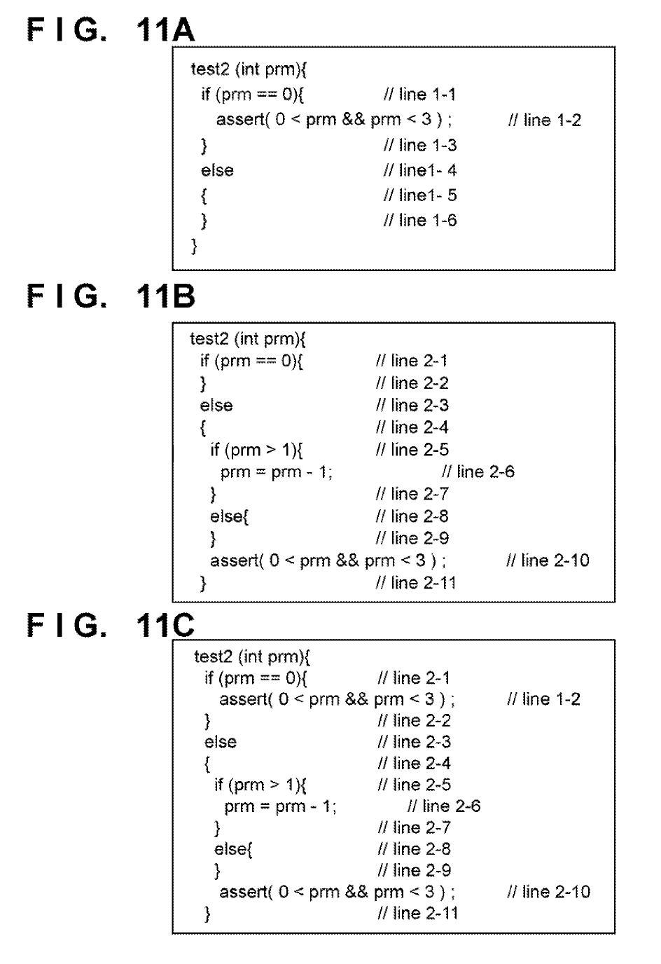

The verification code generating unit 304 generates, from the verification data 310 shown in FIG. 13A, a verification code 311 shown in FIG. 11A with respect to the verification formula with the verification ID #1, and a verification code 311 shown in FIG. 11B with respect to the verification formula with the verification ID #2. Also, as a result of generating the verification code 311, the verification code generating unit 304 sets “Yes” in the code generation field of the verification data and sets the corresponding numbers in the code number field as shown in FIG. 13B.

Subsequently, the verification code composition unit 305 performs processing of composing verification codes for each function. Variable names used in the verification codes 311 shown in FIGS. 11A and 11B are both prm and the types thereof are both integer, and thus the determination result in step S12 in FIG. 8 is “Yes”. However, the code shown in FIG. 11A excluding the verification formula, that is, the code other than the line 1-2 is different from the code shown in FIG. 11B excluding the verification formula, that is, the code other than the line 2-10. Thus, “No” is obtained in step S13 in FIG. 8. However, the verification code shown in FIG. 11B (first verification code) other than the verification formula includes the verification code shown in FIG. 11A (second verification code) other than the verification formula. That is, the lines 1-1, 1-3 to 1-6 correspond respectively to the lines 2-1, 2-2, 2-3, 2-4, and 2-11. Therefore, the verification code composition unit 305 composes the verification codes 311 to form a verification code 312 shown in FIG. 11C, by simply inserting the assert statement, which is the verification formula in the line 1-2 in FIG. 11A, in a position between the lines 2-1 and 2-2 in FIG. 11B, which corresponds to the line 1-2 in FIG. 11A. Also, the verification code composition unit 305 sets the corresponding number in the code number field as shown in FIG. 13C, as a result of generating the composed verification code 312.

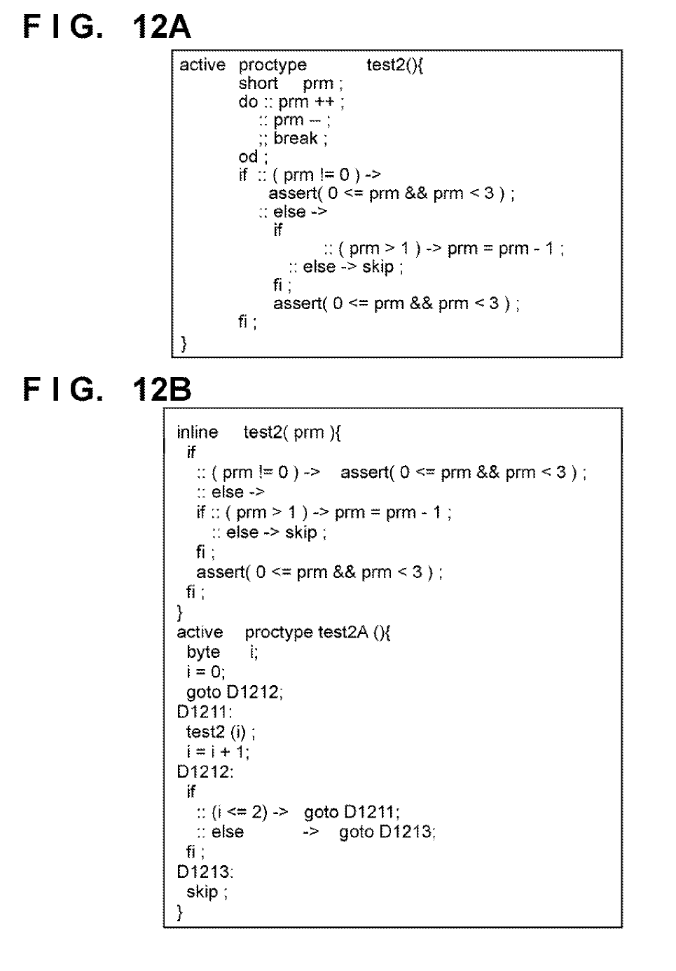

After that, the conversion unit 306 converts the verification code 312 into a verification code 313 that conforms to the model verifying language supported by the program verification apparatus. FIG. 12A indicates a state of the verification code 312 shown in FIG. 11C after conversion when the model verifying language is SPIN. In the function test2 of the program to be verified shown in FIGS. 9 and 10, prm is an out-of-scope variable, and thus the verification execution unit 307 outputs a determination result of “NG” for the verification code 313 shown in FIG. 12A. Accordingly, the control unit 308 controls the units in FIG. 2 such that the verification scope is expanded and the above-described processing is executed again.

As shown in FIG. 10, since the function test2 is called in the line 5 of a function test2A, in the second time of execution, the function test2A is added to the verification scope. The verification code 313 obtained when the function test2A is added to the verification scope is shown in FIG. 12B. Since the specification to be verified is fulfilled (OK) with respect to the verification code 313 of FIG. 12B, the verification execution unit 307 sets “OK” in the verification result field as shown in FIG. 13D.

### Third Embodiment

Next, a case will be described in which the index of an array or the denominator in the division process is not a constant but a variable.

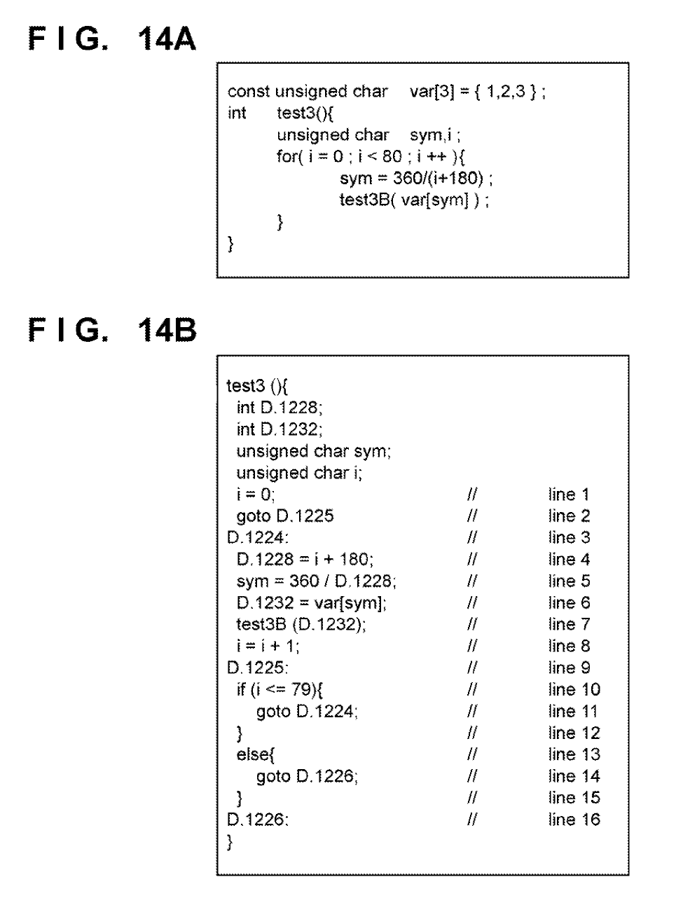

FIG. 14A shows a source code of a program to be verified 309, and FIG. 14B shows a three address code corresponding to the source code shown in FIG. 14A. The following matters can be understood based on the program to be verified 309 shown in FIGS. 14A and 14B.

In the line 5 of a function test3 in FIG. 14B, division by D.1128 is executed.

In the line 6 of the function test3 in FIG. 14B, an array var is accessed using sym as an index.

Based on FIG. 14A, the number of elements of the array var is three.

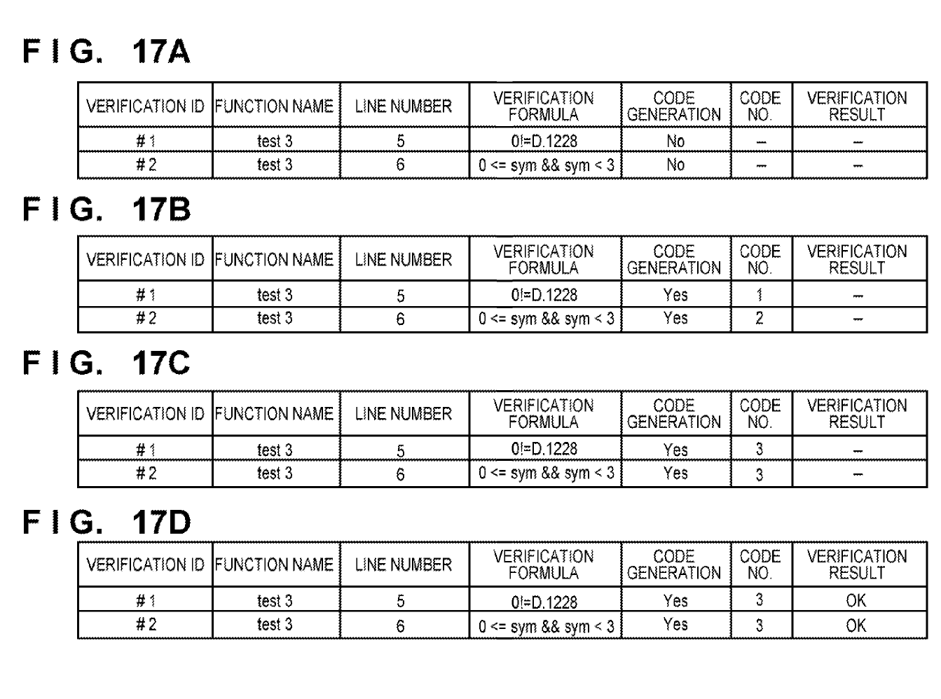

Based on the matters described above, with respect to the function test3, it is understood that with respect to “DIV 0”, it is sufficient to verify whether D.1128 in the line 5 is not 0, and with respect to “out-of-array reference”, it is sufficient to verify whether in access to the array var in the line 6, sym is not less than 0 and not more than 3. The verification formula generating unit 303 accordingly outputs verification data 310 shown in FIG. 17A.

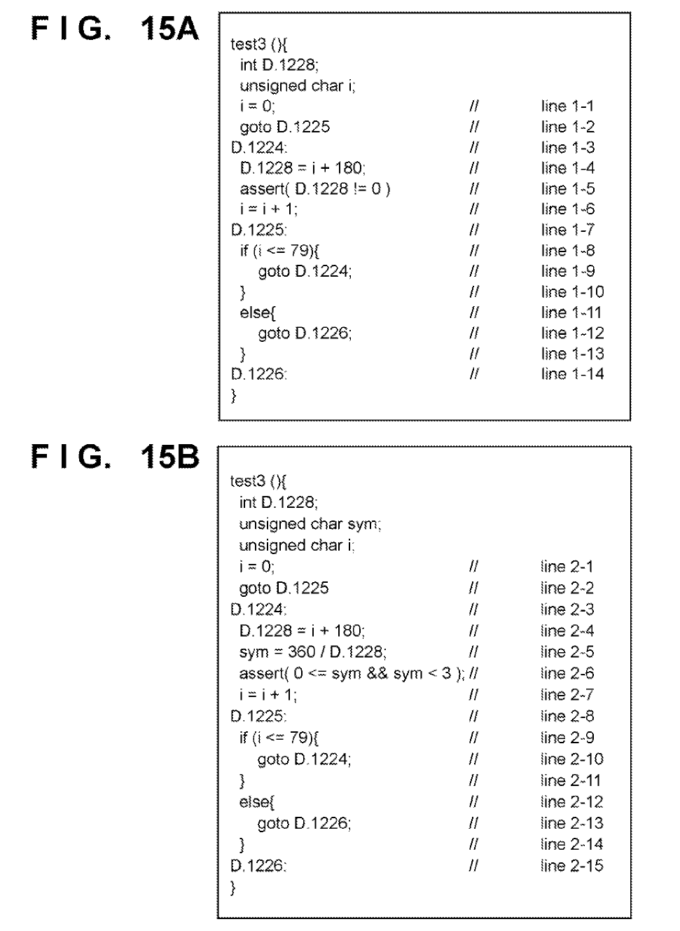

The verification code generating unit 304 generates, from the verification data 310 shown in FIG. 17A, a verification code 311 shown in FIG. 15A with respect to the verification formula with the verification ID #1, and a verification code 311 shown in FIG. 15B with respect to the verification formula with the verification ID #2. Also, as a result of generating the verification code 311, the verification code generating unit 304 sets “Yes” in the code generation field of the verification data and sets the corresponding numbers in the code number field as shown in FIG. 17B.

Next, the verification code composition unit 305 performs processing of composing verification codes for each function. The variables used in the verification code 311 shown in FIG. 15A are D.1228 and i, and the variables used in the verification code 311 shown in FIG. 15B are D.1228, i, and sym, and they are in the inclusion relation. Accordingly, “Yes” is obtained in step S12 in FIG. 8. However, the code shown in FIG. 15A excluding the variables and the verification formula, that is, the code other than the line 1-5, is different from the code shown in FIG. 15B other than the verification formula, that is, the code other than the line 2-6. Thus, “No” is obtained in step S13 in FIG. 8.

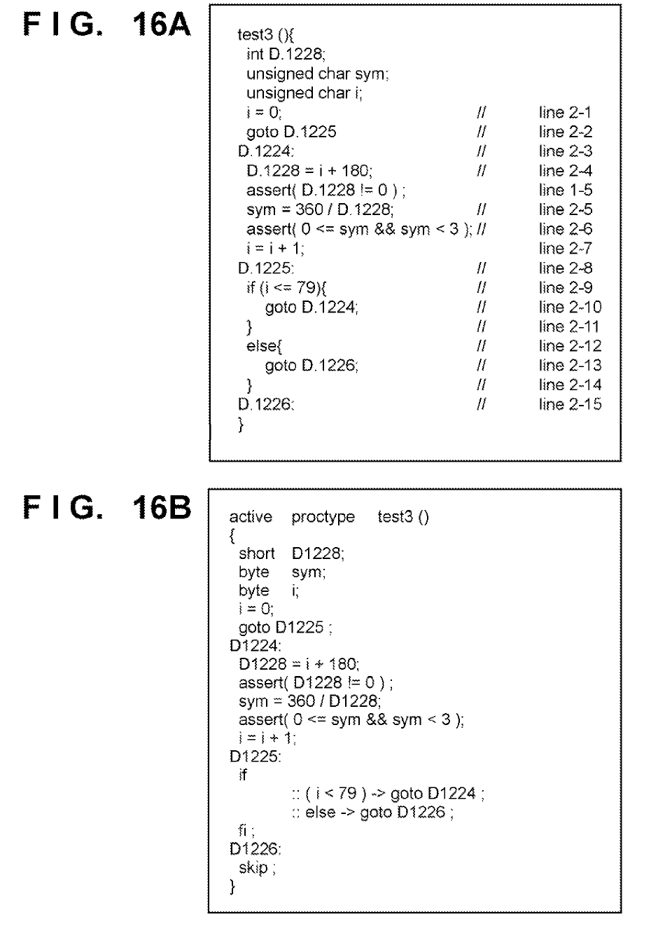

In this case, the verification code composition unit 305 performs composition processing in step S15 in FIG. 8, and generates a composed verification code 312 shown in FIG. 16A. Note that as with the second embodiment, the verification code shown in FIG. 15B other than the verification formula, namely, the line 2-6, includes the verification code shown in FIG. 15A other than the verification formula, namely, the line 1-5. Accordingly, the composition processing is performed by inserting the verification formula in the line 1-5 of the verification code in FIG. 15A in a position in FIG. 15B which corresponds to the verification code in FIG. 15A, that is, a position between the lines 2-4 and 2-5. Also, the corresponding number is set in the code number field as shown in FIG. 17C, as a result of generation of the composed verification code 312.

After that, the conversion unit 306 converts the verification code 312 into a verification code 313 that conforms to the model verifying language supported by the program verification apparatus. FIG. 16B shows a state of the verification code 312 shown in FIG. 16A after conversion when the model verifying language is SPIN. The verification execution unit 307 outputs a determination result of “OK” for the verification code 313 shown in FIG. 16B, and sets “OK” in the verification result field as shown in FIG. 17D.

As described above, it is possible to reduce time required for program verification by generating a verification code corresponding to a verification formula, and if possible, composing a plurality of verification codes to form a single verification code. Also, it is possible to compose verification codes through a simple determination process, by determining whether verification codes in the same function can be composed. Note that if a verification code includes an out-of-scope variable, program verification is performed by generating another verification code that includes a function in which a function corresponding to the verification code including an out-of-scope variable is called, and performing verification again. In this manner, it is possible to perform program verification while suppressing a sharp increase in the number of states. Note that it is determined that two verification codes can be composed when these verification codes correspond to the same function, and at least the variables used in these verification codes are in the inclusion relation. Note that if the variables of the two verification codes are the same and the two verification codes excluding the verification formulae are the same, it is possible to compose the verification formulae of the two verification codes to form a single verification formula. Also, if one verification code excluding the verification formula and variables includes the other verification code excluding the verification formula and variables, it is possible to compose the verification codes by inserting the verification formula of the other verification code into the one verification code. In this manner, the verification code composition processing is simple, and the number of states to be verified can be effectively reduced.

### Other Embodiments

Aspects of the present invention can also be realized by a computer of a system or apparatus or devices such as a CPU or MPU that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-107635, filed on May 12, 2011, which is hereby incorporated by reference herein in its entirety.

What is claimed is:

1. A program verification apparatus comprising:
a verification formula generating unit configured to analyze a content of processing of a program to be verified and generate a verification formula for determining whether or not a specification to be verified out of a language specification of the program to be verified is fulfilled;
a verification code generating unit configured to generate a verification code including the generated verification formula;
a verification code composition unit configured to determine, with respect to at least two verification codes generated by the verification code generating unit, whether or not the two verification codes can be composed to form a single verification code, and compose the two verification codes to form a single verification code if the composition is possible; and
a verification execution unit configured to determine, with respect to the at least two verification codes that can be composed, whether or not the specification to be verified is fulfilled using the verification code composed by the verification code composition unit.

2. The program verification apparatus according to claim 1, wherein the verification execution unit is further configured to execute a verification code composed by the verification code composition unit, and a verification code that has been generated by the verification code generating unit and has not been composed by the verification code composition unit, and determine, for each of the verification codes, whether or not the specification to be verified is fulfilled.

3. The program verification apparatus according to claim 1,
wherein the verification formula generating unit is further configured to analyze a content of processing of the program to be verified to determine a processing portion corresponding to the specification to be verified, and generate, for each of determined processing portions, verification data that includes data indicating the verification formula for the specification to be verified corresponding to the processing portion and a function corresponding to the processing portion,
the verification code generating unit is further configured to generate the verification code for each of the determined processing portions, and
the verification code composition unit is further configured to determine functions to which at least two verification codes generated by the verification code generating unit correspond based on the verification data, and with respect to at least two verification codes corresponding to the same function, determine whether or not the at least two verification codes corresponding to the same function can be composed to form a single verification code.

4. The program verification apparatus according to claim 3, further comprising:
a control unit configured to, in a case where a verification code executed by the verification execution unit does not fulfill a corresponding specification to be verified, determine whether or not a first function corresponding to the executed verification code includes a variable that takes an indefinite value with only the first function, and in a case where there is a variable that takes an indefinite value, identify a second function that calls the first function and cause the program verification apparatus to re-execute verification of the program to be verified,
wherein the verification code generating unit is further configured to, when the verification of the program to be verified is re-executed, refer to the second function when generating a verification code of a processing portion corresponding to the specification to be verified of the first function.

5. The program verification apparatus according to claim 3,
wherein the verification code composition unit is further configured to, in a case where variables used in at least two verification codes generated by the verification code generating unit are in an inclusion relation, determine that the at least two verification codes can be composed.

6. The program verification apparatus according to claim 5,
wherein the verification code composition unit is further configured to, in a case where the variables used in the at least two verification codes are the same, and portions of the at least two verification codes obtained by excluding the verification formulae are the same, compose the verification formulae of the at least two verification codes to form a single verification formula.

7. The program verification apparatus according to claim 5,
wherein the verification code composition unit is further configured to, in a case where a portion of a first verification code obtained by excluding a verification formula and a variable used therein, the first verification code being one of the at least two verification codes, includes a portion of a second verification code obtained by excluding a verification formula and a variable used therein, the second verification code being another verification code of the at least two verification codes, compose the verification codes by inserting the verification formula used in the second verification code into the first verification code.

8. A non-transitory computer readable storage medium storing a program for causing a computer to function as the program verification apparatus of claim 1.
